(19) United States
(12) Patent Application Publication
(10) Pub. No.: US 2013/0194905 A1
(43) Pub. Date: Aug. 1, 2013

(54) OPTICAL PICKUP AND OPTICAL DISK DEVICE USING OPTICAL PICKUP

(71) Applicant: Hitachi Media Electronics Co., Ltd., Oshu-shi (JP)

(72) Inventors: Daisuke TOMITA, Yokohama-shi (JP); Jun HATO, Fujisawa-shi (JP); Kenji KIYA, Fujisawa-shi (JP)

(73) Assignee: Hitachi Media Electronics Co., Ltd., Oshu-shi (JP)

(21) Appl. No.: 13/742,801

(22) Filed: Jan. 16, 2013

(30) Foreign Application Priority Data
Jan. 30, 2012 (JP) 2012-016982

(51) Int. Cl. G11B 7/1365

(52) U.S. Cl. CPC G11B 7/1365
USPC 369/112.17

(57) ABSTRACT

In an optical pickup for an optical disk device using BD, DVD and CD as recording media, simplification of constitutional elements is promoted. The optical pickup includes a dual wavelength type laser beam source generating laser beams for DVD and CD, a single wavelength type laser beam source generating a laser beam for BD, and a first wave plate converting the laser beam for BD generated from the laser beam source concerned into circular polarization. It further includes a second wave plate converting the laser beam for DVD generated from the dual wavelength type laser beam source into 45-degree linear polarization. Favorable recording and reproduction are performed by radiating the laser beam to the recording medium concerned as the circular polarization for BD and the 45-degree linear polarization for DVD.

### INCORPORATION BY REFERENCE

This application relates to and claims priority from Japanese Patent Application No. 2012-016982 filed on Jan. 30, 2012, the entire disclosure of which is incorporated herein by reference

### BACKGROUND OF THE INVENTION

(1) Field of the Invention

The present invention relates to an optical pickup and an optical disk device using the optical pickup, and more particularly to an optical pickup whose constitutional elements are simplified and an optical disk device using the optical pickup.

(2) Description of the Related Art

In the optical disk device, the number of kinds of recording media used is being increased as represented by a CD (Compact Disk), a DVD (Digital Versatile Disk) and a BD (Blu-ray Disk). In the optical pickup used to record and reproduce information data by radiating a laser beam to a recording medium concerned, it is desirable to use laser beams which are different from one another in wavelength depending on the recording media used. Therefore, a dual wavelength type laser beam source coping with, for example, the DVD and the CD has already been put into practical use.

In Japanese Patent Application Laid-Open No. 2003-317280, an optical pickup device having a dual wavelength type laser beam source is disclosed.

### SUMMARY OF THE INVENTION

In an optical pickup coping with a plurality of wavelengths of laser beams, it is important to design a wave plate which is built into it such that laser beams of the plurality of wavelengths, particularly, the laser beams of short wavelengths are radiated onto the recording media in predetermined polarization directions. This allows recording and reproduction of information data which is high in recording density at a low error rate by using a short-wavelength laser beam.

In the above mentioned case, a method that a plurality of wave plates is stacked or materials are used in a mixed state so as to make the wave plate cope with any of laser beams of mutually different wavelengths is conceivable. However this method is not desirable for reasons that it makes production of the wave plate difficult and the cost involved is increased.

Nothing is disclosed in Japanese Patent Application Laid-Open No. 2003-317280 with respect the above mentioned disadvantage.

The present invention has been made in view of the above mentioned disadvantage and aims to provide an optical pickup simplified in constitutional element and coping with laser beams of three wavelengths while maintaining its fundamental performance, and an optical disk device using the optical pickup.

In order to solve the above mentioned disadvantage, according to an embodiment of the present invention, there is provided an optical pickup used in an optical disk device radiating laser beams to mutually different kinds of first, second and third optical disks to read out information data from the disks, including a first laser beam source generating a laser beam of a first wavelength to be radiated to the first optical disk, a second laser beam source generating a laser beam of a second wavelength which is longer in wavelength than the laser beam of the first wavelength and is to be radiated to the second optical disk, and a laser beam of a third wavelength which is longer in wavelength than the second wavelength and is to be radiated to the third optical disk, a second wave plate letting the laser beam of the second wavelength generated from the second laser beam source input, giving the laser beam of the second wavelength a phase difference and then letting the laser beam of the second wavelength output, and letting the laser beam of the third wavelength input and letting the laser beam of the third wavelength output, a first wave plate letting the laser beam of the first wavelength generated from the first laser beam source input, converting the laser beam of the first wavelength into circular polarization and then letting laser beam so converted into the circular polarization output, letting the laser beam of the second wavelength that has outputted the second wave plate input as 45-degree linear polarization and letting the laser beam of the second wavelength output still as the 45-degree linear polarization, and letting the laser beam of the third wavelength that has outputted the second wave plate input and letting the laser beam of the third wavelength output and an objective lens making the laser beams of the first to third wavelengths that have outputted the first wave plate focus on the first to third optical disks.

According to an embodiment of the present invention, there is also provided an optical pickup used in an optical disk device radiating laser beams to mutually different kinds of first, second and third optical disks to read out information data from the disks, including a first laser beam source generating a laser beam of a first wavelength to be radiated to the first optical disk, a second laser beam source generating a laser beam of a second wavelength which is longer in wavelength than the laser beam of the first wavelength and is to be radiated to the second optical disk, and a laser beam of a third wavelength which is longer in wavelength than the second wavelength and is to be radiated to the third optical disk, a second wave plate letting the laser beam of the second wavelength generated from the second laser beam source input, giving the laser beam of the second wavelength a phase difference and then letting the laser beam of the second wavelength output, and letting the laser beam of the third wavelength input and letting the laser beam of the third wavelength output, a first wave plate letting the laser beam of the first wavelength generated from the first laser beam source input, converting the laser beam of the first wavelength into circular polarization and then letting the laser beam so converted into the circular polarization output, letting the laser beam of the second wavelength that has outputted the second wave plate input, converting the laser beam of the second wavelength into circular polarization and then letting the laser beam so converted into the circular polarization, and letting the laser beam of the third wavelength that has outputted the second wave plate input and letting the laser beam of the third wavelength output and an objective lens making the laser beams of the first to third wavelengths that have outputted the first wave plate focus on the first to third optical disks.

According to an embodiment of the present invention, there is also provided an optical pickup used in an optical disk device radiating laser beams to mutually different kinds of first, second and third optical disks to read out information data from the disks, including a first laser beam source generating a laser beam of a first wavelength to be radiated to the first optical disk, a second laser beam source generating a laser beam of a second wavelength which is longer in wavelength than the laser beam of the first wavelength and is to be radiated to the second optical disk, and a laser beam of a third wavelength which is longer in wavelength than the second wavelength and is to be radiated to the third optical disk, a second wave plate letting the laser beam of the first wavelength generated from the second laser beam source input, giving the laser beam of the first wavelength a phase difference and then letting the laser beam of the second wavelength output, a first wave plate letting the laser beam of the first wavelength that has outputted second wave plate input as 45-degree linear polarization and letting the laser beam of the first wavelength output still as the 45-degree linear polarization, letting the laser beam of the second wavelength generated from the second laser beam source input, converting the laser beam of the second wavelength into circular polarization and then letting the laser beam so converted into the circular polarization output, and letting the laser beam of the third wavelength generated from the second laser beam source input and letting the laser beam of the third wavelength output and an objective lens making the laser beams of the first to third wavelengths that have outputted the first wave plate focus on the first to third optical disks.

According to an embodiment of the present invention, there is also provided an optical pickup used in an optical disk device radiating laser beams to mutually different kinds of first, second and third optical disks to read out information data from the disks, including a first laser beam source generating a laser beam of a first wavelength to be radiated to the first optical disk, a second laser beam source generating a laser beam of a second wavelength which is longer in wavelength than the laser beam of the first wavelength and is to be radiated to the second optical disk, and a laser beam of a third wavelength which is longer in wavelength than the second wavelength and is to be radiated to the third optical disk, a second wave plate letting the laser beam of the first wavelength generated from the first laser beam source input, giving the laser beam of the first wavelength a phase difference and then letting the laser beam of the first wavelength output, a first wave plate letting the laser beam of the first wavelength that has outputted the second wave plate input, converting the laser beam of the first wavelength into circular polarization and then letting the laser beam so converted into the circular polarization output, letting the laser beam of the second wavelength generated from the second laser beam source input, converting the laser beam of the second wavelength into circular polarization and then letting the laser beam so converted into the circular polarization output, and letting the laser beam of the third wavelength generated from the second laser beam source and letting the laser beam of the third wavelength output and an objective lens making the laser beams of the first to third wavelengths that have outputted the first wave plate focus on the first to third optical disks.

According to an embodiment of the present invention, there is also provided an optical pickup used in an optical disk device radiating laser beams to mutually different kinds of first, second and third optical disks to read out information data from the disks, including a first laser beam source generating a laser beam of a first wavelength to be radiated to the first optical disk, a second laser beam source generating both of a laser beam of a second wavelength which is longer in wavelength than the laser beam of the first wavelength and is to be radiated to the second optical disk and a laser beam of a third wavelength which is longer in wavelength than the second wavelength and is to be radiated to the third optical disk so as to be different from the laser beam of the first wavelength in polarization direction by 45 degrees, a wave plate letting the laser beam of the first wavelength generated from the first laser beam source input, converting the laser beam of the first wavelength into circular polarization and then letting the laser beam so converted into the circular polarization output, and letting the laser beams of the second and third wavelengths generated from the second laser beam source input and letting the laser beams of the second and third wavelengths still as 45-degree polarizations and an objective lens making the laser beams of the first to third wavelengths that have outputted the wave plate focus on the first to third optical disks.

According to an embodiment of the present invention, there is also provide an optical pickup used in an optical disk device radiating laser beams to mutually different kinds of first, second and third optical disks to read out information data from the disks, including a first laser beam source generating a laser beam of a first wavelength to be radiated to the first optical disk, a second laser beam source generating both of a laser beam of a second wavelength which is longer in wavelength than the laser beam of the first wavelength and is to be radiated to the second optical disk and a laser beam of a third wavelength which is longer in wavelength than the second wavelength and is to be radiated to the third optical disk, and generating the laser beams such that at least the laser beam of the second wavelength is different from the laser beam of the first wavelength in polarization direction by 45 degrees, a wave plate 1 letting the laser beam of the first wavelength generated from the first laser beam source input and letting the laser beam of the first wavelength output as e45-degree linear polarization, letting the laser beam of the second wavelength generated from the second laser beam source input, converting the laser beam of the second wavelength into circular polarization and then letting the laser beam of the second wavelength so converted into the circular polarization output, and letting the laser beam of the third wavelength generated from the second laser beam source input and letting the laser beam of the third wavelength output and an objective lens making the laser beams of the first to third wavelengths that have outputted the wave plate focus on the first to third optical disks.

According to an embodiment of the present invention, there is also provided an optical disk device using optical pickup, including the optical pickup and a signal processing unit processing information data read out from the optical disks.

The present invention allows provision of the optical pickup whose constitutional elements are simplified and the optical disk device using the optical pickup and has such an effect that it contributes to spreading use of the optical pickup and the optical disk device coping with various recording media including the BD, particularly.

### BRIEF DESCRIPTION OF THE DRAWINGS

These and other features, objects and advantages of the present invention will become more apparent from the following description when taken in conjunction with the accompanying drawings wherein:

FIG. 1 is a block diagram illustrating an example of an optical disk device according to one embodiment;

FIG. 2 is a first block diagram illustrating an example of an optical pickup according to one embodiment;

FIG. 3 is a first diagram illustrating an example of a relation between a polarization direction of incident light and outgoing light;

FIG. 4 is a second diagram illustrating an example of a relation between a polarization direction of incident light and outgoing light;

FIG. 5 is a second block diagram illustrating an example of an optical pickup according to one embodiment; and

FIG. 6 is a third block diagram illustrating an example of an optical pickup according to one embodiment.

### DETAILED DESCRIPTION OF THE EMBODIMENTS

Hereinafter, embodiments of the present invention will be described with reference to the accompanying drawings. First, general operations of an optical disk device using an optical pickup according to the embodiments will be described.

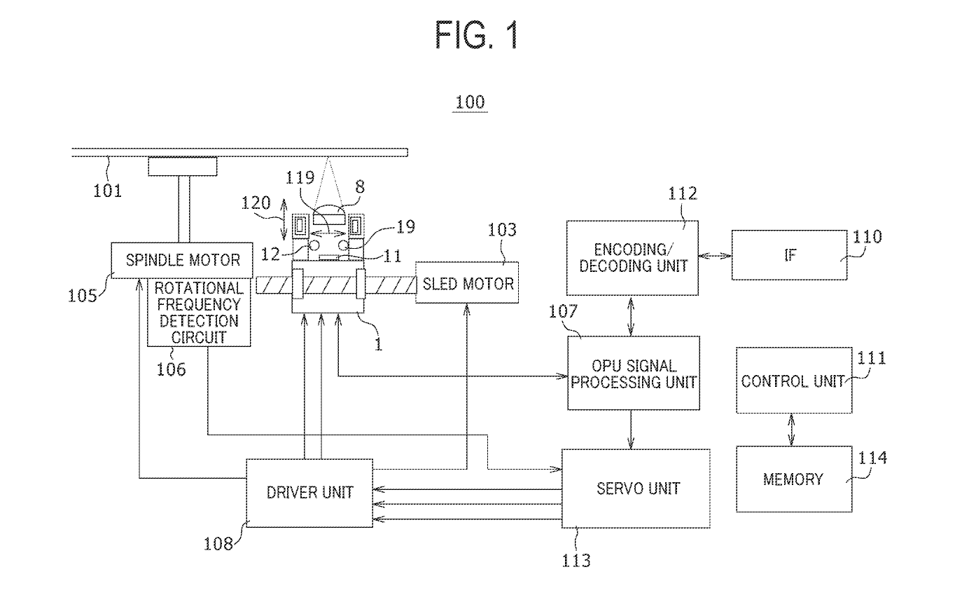

FIG. 1 is a block diagram illustrating an example of an optical disk device 100 according to one embodiment. An optical disk 101 which is a recording medium is, for example, a CD, a DVD, or a BD. It is apparent that the optical disk may be any of a direct read after write type one which is writable once such as a CD-R, a DVD-R or a BD-R, a rewritable type one such as a CD-RW, a DVD-RAM or a BD-RE, and a read only type one such as a CD-ROM, a DVD-ROM, or a BD-ROM. The optical disk 101 is loaded on a not illustrated disk tray type or slim slot type loading mechanism, is inserted into the optical disk 100 and is mounted on an extension of a shaft of a spindle motor 105.

The optical disk 101 so mounted is rotationally driven so as to attain a predetermined rotating speed (for example, a rotating speed at which a liner velocity is attained at a position where data is recorded and/or reproduced) by the spindle motor 105. A spindle motor drive signal used for this purpose is generated by a servo unit 113, is power-amplified by a driver unit 108 and is supplied to the spindle motor 105. A rotational frequency detection circuit 106 is disposed for generating the spindle motor drive signal from the servo unit 113 and a signal indicating the rotational frequency of the spindle motor 105 that the rotational frequency detection circuit 106 generates is supplied to the servo unit 113.

An optical pickup 1 is loaded on a sled mechanism and moves in a radius direction of the optical disk 101 with rotation of a sled motor 103 to perform data recording and reproduction at a predetermined position on a track. A sled motor drive signal used for this purpose is generated by the servo unit 113, is power-amplified by the driver unit 108 and then is supplied to the sled motor 103.

An objective lens 8 that the optical pickup 1 includes is loaded on a tracking actuator 119 and a focus actuator 120 using electromagnetic force (in FIG. 1, only directions in which the actuators 119 and 120 drive the objective lens 8 are illustrated in order to avoid complication).

A tracking actuator drive signal obtained by processing a tracking control signal generated by the servo unit 113 by the driver unit 108 is supplied to the tracking actuator 119.

The position in a radius direction (a tracking direction) of the objective lens 8 relative to the optical disk 101 is finely adjusted such that a flux of laser beams generated by a laser beam source 12 or 19 correctly traces on a predetermined recording track of the optical disk 101 on the basis of the tracking actuator drive signal so supplied.

Incidentally, it is assumed that the laser beam source 12 is a dual wavelength type laser beam source used when the optical disk 101 is the CD or the DVD, and the laser beam source 19 is a single wavelength type laser beam source used when the optical disk 101 is the BD.

In addition, a focus actuator drive signal obtained by processing a focus control signal generated by the servo unit 113 by the driver unit 108 is supplied to the focus actuator 120. The position in a vertical direction (a focusing direction) of the objective lens 8 relative to the optical disk 101 is finely adjusted such that a flux of laser beams generated by the laser beam source 12 or 19 is correctly focused on a predetermined recording track of the optical disk 101 on the basis of the focus actuator drive signal so supplied.

A photodetector 11 that the optical pickup 1 includes detects light of the flux of laser beams reflected from the optical disk 101, detects an information signal recorded on the optical disk 101 and converts the signal so detected into an electric signal. The information signal so detected is supplied to an OPU (Optical Pick Up) signal processing unit 107. The OPU signal processing unit 107 arithmetically processes the information signal, generates, for example, a tracking error signal and a focus error signal and then supplies the tracking and focus error signals so generated to the servo unit 113.

The servo unit 113 processes the supplied tracking error signal and focus error signal and supplies the processed signals to the previously described driver unit 108.

An actuator drive circuit that the driver unit 108 includes generates the previously described tracking actuator drive signal and focus actuator drive signal on the basis of the error signals so supplied and supplies the generated tracking actuator and focus actuator drive signals respectively to the tracking actuator 119 and the focus actuator 120. As a result, predetermined tracking servo control and focus servo control are performed on the objective lens 8 of the optical pickup 1.

Further, the OPU signal processing unit 107 equalizes frequency characteristics of amplitudes and phases when the data has been recorded on and reproduced from the optical disk 101 and supplies the equalized data to an encoding/decoding unit 112. The encoding/decoding unit 112 performs a process of reproducing the information signal recorded on the optical disk 101. For example, the encoding/decoding unit 112 demodulates the information signal in accordance with a modulating method performed when the information signal has been recorded on the optical disk 101 and decodes the information signal so demodulated in accordance with an encoding method concerned. In addition, the encoding/decoding unit 112 performs an error correcting process using an error correction code that has been appended to the information signal when recording the information signal. As a result, the original information signal is decoded. The information signal so decoded is temporarily stored in a memory 114 on the basis of an instruction from a control unit 111.

The above mentioned operations of the optical disk device 100 are performed on the basis of control signals generated by the control unit 111. Incidentally, the control unit 111 includes, for example, a microcomputer.

In addition, an operating command or the like issued from, for example, a user is generated by a host computer (not illustrated) which is a host device of the optical disk device 100. An IF (interface) unit 110 intermediates communications between the host device and the optical disk device 100 to transmit a command signal generated by the host computer concerned to the optical disk device 100.

The information signal that has been temporarily stored in the memory 114 is supplied to the host computer via the IF unit 110. On the other hand, an information signal supplied from the host computer via the IF unit 110 is temporarily stored in the memory 114, then, for example, the above mentioned error correction code is appended to the information signal by the encoding/decoding unit 112, the information signal with the error correction code appended is subjected to predetermined record encoding and modulation processing, is power-amplified to a value suited to be supplied to the optical pickup 1 by the OPU signal processing unit 107, and is recorded on a recording track of the optical disk 101 via the flux of laser beams that the laser beam source 12 or 19 included in the optical pickup 1 generates. Incidentally, an optical disk device not having the signal recording functions mentioned above but having only a signal reproducing function also falls within the range of the present embodiment.

The memory 114 also stores many OSs (Operating Systems) and applications for operating the control unit 111 in addition to storage of the information signals to be recorded and reproduced. Therefore, the memory 114 may include not only a readable and writable RAM (Random Access Memory) or a flash memory, but also, for example, a programmable flash ROM (Read Only Memory).

Incidentally, although many constitutional elements that function as electrical circuits are individually illustrated in FIG. 1, it goes without saying that these constitutional elements may be integrated into a large-scale integrated semiconductor device.

In addition, although the control unit 111 is connected not only with the memory 114 but also with almost all the constitutional elements that function as the electrical circuits in order to control the general operation of the optical disk device 100, connection lines used for this purpose are omitted in order to avoid complication of the drawing in FIG. 1.

Next, the optical pickup 1 in the present application will be described in detail.

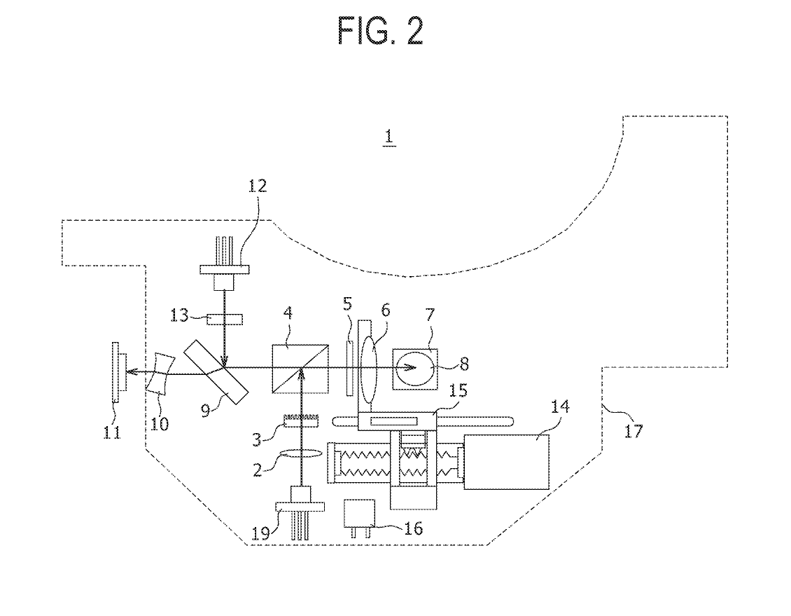

FIG. 2 is a first block diagram illustrating an example of the optical pickup 1 according to one embodiment. First, the general operation of the optical pickup 1 will be described.

An output signal from the previously described OPU signal processing unit 107 is supplied to the laser beam sources 12 and 19. When the optical disk 101 is the CD, the laser beam source 12 functions and generates a laser beam of a wavelength on the order of, for example, 795 nm. When the optical disk 101 is the DVD, the laser beam source 12 functions and generates a laser beam of a wavelength on the order of, for example, 656 nm. That is, the laser beam source 12 is a dual wavelength type laser beam source that includes two closely installed laser diodes that generate laser beams of mutually different wavelengths.

When the optical disk 101 is the CD or the DVD, the laser beam generated from the laser beam source 12 is reflected by a surface of a half mirror 9 via a diffraction grating 13, passes through a prism 4 and a first wave plate 5, is shaped into collimated light by a collimator lens 6, is totally reflected by a total reflection mirror 7, and then is radiated so as to be focused on the optical disk 101 via the objective lens 8. Incidentally, although the optical disk 101 is not illustrated in FIG. 2, it is situated in front of the optical pickup 1 with its disk surface oriented in a direction parallel with the drawing. The objective lens 8 is situated in front of the total reflection mirror 7 on the drawing. That is, the laser beam travels backward between the total reflection mirror 7 and the objective lens 8 on the drawing.

On the other hand, when the optical disk 101 is the BD, the laser beam generated from the laser beam source 19 is reflected by a split surface of the prism 4 via an auxiliary lens 2 and a diffraction grating 3, passes through the first wave plate 5, is shaped into collimated light by the collimator lens 6, is totally reflected by the total reflection mirror 7 and then is radiated so as to be focused on the optical disk 101 via the objective lens 8.

When information data is to be recorded on the optical disk 101, the output signal from the previously described OPU signal processing unit 107 includes the information data. Thus, that information data is recorded on the optical disk 101. Incidentally, it is supposed that power values of the laser beams generated from the laser beam sources 12 and 19 are predetermined values determined in accordance with the kind of the optical disk 101 used and its recording layer in which the data is to be recorded.

In the case that information data recorded on the optical disk 101 is to be read, when the optical disk 101 is the CD or the DVD, the laser beam source 12 generates the laser beam of the same wavelength as the above, while when the optical disk 101 is the BD, the laser beam source 19 generates the laser beam of the same wavelength as the above. Although the power value of the laser beam so generated from each of the laser beam sources 12 and 19 is the predetermined value determined in accordance with the kind of the optical disk 101 used and its recording layer in which the data is recorded, it has a value which is greatly smaller than the value used when the above mentioned information data has been recorded. In that case, the laser beam generated from the laser beam source 12 or 19 is radiated to the optical disk 101 through the same optical path as that used when the information data has been recorded.

The laser beam reflected from the optical disk 101 includes the information data recorded on the optical disk 101. That laser beam is totally reflected by the total reflection mirror 7 via the objective lens 8, then passes through the collimator lens 6, the first wave plate 5 and the prism 4, then passes through the half mirror 9, and is focused on the photodetector 11 by the action of a detective lens 10. The photodetector 11 converts the detected laser beam into an electric signal and supplies the electric signal to the previously described OPU signal processing unit 107. As a result, the information data recorded on the optical disk 101 is read out.

Other constitutional elements illustrated in FIG. 2 will be described. A collimator lens holder 15 holds the previously described collimator lens 6 and finely adjusts the position of the collimator lens 6 in a lateral direction on the drawing with rotation of a stepping motor 14. This operation is performed in order to correct a difference in spherical aberration depending on the wavelength of the laser beam used, and the laser beam of each wavelength is shaped into collimated light at the stage that it passes through the collimator lens 8. A reset detector 16 is an end sensor disposed on the inner periphery side of the optical disk 101 and detects whether the optical pickup 1 is situated at its initial position on the inner periphery side. The reset detector 16 may be implemented by either an optical method or a method using a mechanical switch. A housing 17 sets the constitutional elements of the optical pickup 1 in position. Here, one example of its shape is illustrated by a broken line.

Incidentally, in the foregoing description, detailed description of the actions of several constitutional elements is omitted. For example, the diffraction gratings 3 and 13 are the constitutional elements that each prepares three beams of straight light, plus primary diffracted light and minus primary diffracted light from an incident light beam so as to generate the above mentioned tracking error signal and focus error signal. However, since the direct relation with these elements is little in the present embodiment, detailed description thereof is omitted. On the other hand, the first wave plate 5, and later described second wave plates 18 and 20 will be described in detail later.

Next, polarization of laser beams radiated to the optical disk 101 will be described. The laser beams are in the form of linear polarization when generated from the laser beam sources 12 and 19. On the other hand, in general, it is said to be preferable that the laser beam be radiated to the optical disk 101 in the form of circular polarization or 45-degree linear polarization (advanced in phase by a quarter-wavelength). It is also said that the circular polarization or 45-degree linear polarization is preferable, particularly, for an optical disk which is short in wavelength of the laser beam used and high in recording density, in order to increase the quality of information data to be recorded on and reproduced from that optical disk. The first wave plate 5 is installed in order to convert the laser beams generated from each of the laser beam sources 12 and 19 into predetermined polarization in the example illustrated in FIG. 2.

Next, the actions of wave plates represented by the first wave plate 5 will be described.

A wave plate has a direction in which the phase of light is advanced (a phase advancing axial direction) and a direction in which the phase of light is delayed (a phase delaying axial direction) in a two-dimensional direction of its plate plane, for example, by deforming the shape of a molecule of the material thereof by a predetermined amount in a predetermined direction. The phase advancing axis and the phase delaying axis are orthogonal to each other and the phase advancing axis is also called an optical axis. The wave plate is designed such that a phase advancing component and a phase delaying component are generated in accordance with the polarization direction of a laser beam which has been incident and the laser beam outputs with a phase difference added.

The first wave plate 5 illustrated in FIG. 2 is a quarter wave plate. The quarter wave plate is designed to let a component of light which is advanced in phase by a one-eighth wavelength and a component of light which is delayed in phase by a one-eighth wavelength output depending on the polarization direction of the incident laser beam. That is, the quarter wave plate lets the laser beam having a phase difference of a quarter-wavelength relative to the incident laser beam output.

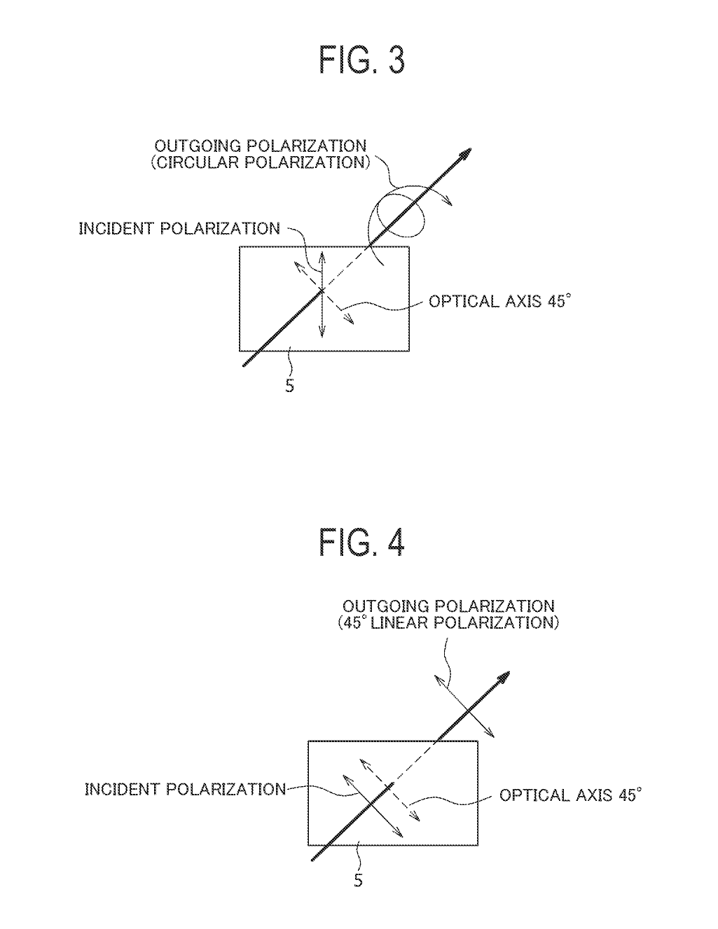

FIG. 3 is a first diagram illustrating an example of a relation between a polarization direction of incident light and outgoing light, illustrating a case that when the first wave plate 5 functions as a quarter wave plate for the incident light, the polarization direction of the incident light which is linear polarization has an angle of 45 degrees relative to the optical axis. In the above mentioned case, the laser beam which has been incident as the linear polarization is converted into circular polarization and outputs the wave plate.

When the polarizing direction of the incident light relative to the optical axis is gradually shifted from 45 degrees, the outgoing light is converted into elliptic polarization.

FIG. 4 is a second diagram illustrating an example of a relation between a polarization direction of incident light and outgoing light, illustrating a case that the polarization direction of the incident light which is the linear polarization matches the optical axis. In the above mentioned case, the laser beam when has been incident as the linear polarization outputs still as the linear polarization.

Incidentally, in the case that the polarization direction of the incident light matches the optical axis as illustrated in FIG. 4, the laser beam which has been incident as the linear polarization outputs still as the linear polarization not depending on the wavelength of the laser beam.

That is, when the relation between the incident light and the optical axis is gradually changed from the state illustrated in FIG. 3 to the state illustrated in FIG. 4, the laser beam that outputs the first wave plate 5 turns into the circular polarization, into the elliptic polarization and then into the linear polarization. Since desirable outgoing light is the circular polarization or the 45-degree linear polarization as mentioned above, it is desirable that the relation between the incident light and the optical axis be as illustrated in FIG. 3 or FIG. 4.

However, a phase shifting amount of light in the wave plate has a dependency on the wavelength, and a quarter wave plate designed to be suited for the laser beam for BD (on the order of 405 nm in wavelength) gives phase shifting amounts which are different from the quarter-wavelength to the laser beam for DVD (on the order of 656 nm in wavelength) and the laser beam for the CD (on the order of 795 nm in wavelength). Even if the quarter wave plate designed as mentioned above is allowed to let, for example, the laser beam for BD output as the circular polarization, it will be difficult for the quarter wave plate to let, for example, the laser beam for the DVD output as the circular polarization. Thus, when laser beams having a plurality of wavelengths are to be handled, it is desirable to further device ways and means.

As one method conceived in order to cope with the above mentioned subject matter, there exists one method of preparing a wave plate having a multi-layered structure formed by piling up wavelength plats having various phase differences to configure the first wave plate 5 that functions as the quarter wave plate for each of the BD, the DVD and the CD. In addition, there exists another method of configuring the first wave plate 5 by a material prepared by mixing together three kinds of molecules of different molecular shapes. A wave plate prepared in the above mentioned manner is called a triple wavelength compatible wave plate. However, both the two methods have such disadvantages that it becomes difficult to produce the first wave plate and the cost is increased.

The quality problem will hardly occur in the CD which is comparatively long in wavelength of the laser beam used and is low in recording density even if not so much importance is attached to the polarization direction. However, it is desirable that the laser beams be radiated to the BD and the DVD in the form of the circular polarization or 45-degree linear polarization.

Therefore, in the present embodiment, the first wave plate 5 is designed as a quarter wave plate coping with the wavelength of the laser beam used for the BD first in the example in FIG. 2. The optical axis thereof is designed to have an angle of 45 degrees relative to the polarization direction of the incident laser beam for BD as illustrated in FIG. 3. Thus, the first wave plate 5 lets the laser beam for BD output as the circular polarization. However, in the above mentioned case, although the first wave plate and the optical axis are designed optimally to the BD as they are, it may not be said that they are designed optimally to the DVD and the CD. It is desirable to design the first wave plate and the optical axis also optimally to the DVD, in particular. As a first method conceived in order to cope with the above mentioned matter, there exists a method of attaching the laser beam source 12 for DVD and CD at an inclination which is larger than a predetermined angle by 45 degrees and generating the laser beam at least for DVD and for both of DVD and CD as required from the laser beam source 12 as the 45-degree polarization. Then, the laser beam generated from the laser beam source 12 will be radiated to the optical disk 101 passing through the first wave plate 5 still as the 45-degree linear polarization as illustrated in FIG. 4.

Or, the first wave plate 5 is designed as the quarter wave plate coping with the wavelength of the laser beam for DVD, contrary to the above. Then, the optical axis thereof is designed to have an angle of 45 degrees relative to the polarization direction of the incident laser beam for DVD. As a result, the first wave plate 5 lets the laser beam for DVD output as the circular polarization. There also exists a method of attaching the laser beam source 19 for BD at an inclination which is larger than a predetermined angle by 45 degrees and generating the laser beam for BD from the laser beam source 19 as the 45-degree linear polarization. Then, the laser beam generated from the laser beam source 19 will be radiated to the optical disk 101 passing through the first wave plate 5 still as the 45-degree linear polarization.

The above mentioned measures may be used as one method for solving the subject matters. However, it is desirable to change the structure of a light receiving surface of the photodetector 11 in accordance with the attaching angle of the laser beam source. Under present conditions, use of the photodetector which is not so generally used is unavoidable and hence the cost involved may be increased. Therefore, it would be rather preferable to conceive of another method.

For reasons as mentioned above, in the present embodiment, a method of making the laser beam pass through a freshly installed wave plate directly after generated from the laser light source 12 is used as a second method.

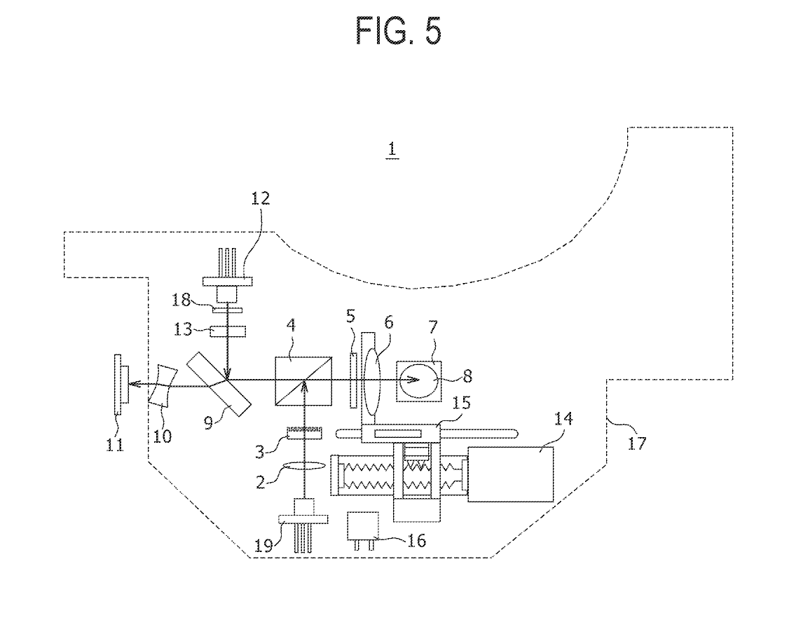

FIG. 5 is a second block diagram illustrating an example of the optical pickup 1 according to an embodiment. In this embodiment, the second wave plate 18 is disposed between the laser beam source 12 and the diffraction grating 13 differently from the embodiment illustrated in FIG. 2.

The second wave plate 18 is a half wave plate for the laser beam for the DVD. The half wave plate is designed such that a component of light which is advanced in phase by a quarter-wavelength and a component of light which is delayed in phase by a quarter-wavelength output in accordance with the polarization direction of the incident laser beam. That is, the laser beam having a phase difference of a half wavelength relative to the incident laser beam outputs the second wave plate 18. The optical axis thereof is designed so as to have an angle of 45 degrees relative to the polarization direction of the incident laser beam. Then, the laser beam for the DVD which has been incident upon the second wave plate 18 from the laser beam source 12 will output as 45-degree linear polarization and will be radiated to the optical disk in the form of DVD. The laser beam for CD outputs without being converted into the 45-degree linear polarization. However, no particular disadvantage is encountered in case of the CD as mentioned above.

In the above mentioned case, since no change is made on the optical path of the laser beam for BD generated from the laser light source 19, the laser beam for the BD is radiated to the optical disc which is in the form of BD as circular polarization. That is, the laser beam which is favorably polarized is radiated to the optical disk 101 except the laser beam for CD in which polarization of the laser beam causes no particular disadvantage. It is allowed to provide the embodiment that the constitutional elements are simplified in comparison with a case that the specific constitutional element is used as the first wave plate 5 or the photodetector 11 as mentioned above.

Incidentally, in the forgoing description, the second wave plate 18 is designed as the half wave plate for the laser beam for DVD. However, in general, it is not limited to the half wave plate. It is sufficient that the second wave plate 18 be designed to let the laser beam for DVD output in a state that a phase difference is given to the laser beam for DVD so as to be converted into the 45-degree linear polarization within a time period from when the laser beam for DVD has been incident upon the second wave plate 18 to when the laser beam for DVD is incident upon the first wave plate 5.

Next, a method of using the wave plate 18 that is designed differently from that in the second method will be described as a third method.

In this case, the second wave plate 18 illustrated in FIG. 5 is designed to let the laser beam for DVD output in a state that a phase difference with which 62.75 nm which is a difference between a quarter of the wavelength of the laser beam for BD and a quarter of the wavelength of the laser beam for DVD is corrected is given. Then, when the laser beam for DVD passes through the first wave plate 5, the laser beam for DVD is converted into the circular polarization similarly to the laser beam for BD and is radiated to the optical disk which is in the form of DVD. That is, the laser beam for DVD and the laser beam for BD are radiated to the optical disk 101 in the form of circular polarization except the laser beam for CD in which polarization of the laser beam causes no particular disadvantage.

Incidentally, as for the method of giving the laser beam for DVD a phase difference with which 62.75 nm which is the difference between the quarter of the wavelength of the laser beam for BD and the quarter of the wavelength of the laser beam for DVD is corrected, other methods are conceivable. For example, a method that the second wave plate 18 works with the half mirror 9 to correct the difference amounting to 62.75 nm is conceivable. The constitutional element that corrects the difference is not limited to the wave plate, and correction may be made combining with a phase shift amount by another constitutional element as mentioned above. That is, it is desirable to design the second wave plate 18 such that correction of the difference amounting to 62.75 nm is made within a time period from when the laser beam generated from the laser beam source 12 has been incident upon the second wave plate 18 to when the laser beam is incident upon the first wave plate 5.

As a modified example of the above mentioned second and third methods, there is also conceivable a method that the first wave plate 5 is designed as a quarter wave plate which is optimized to the wavelength of the laser beam for DVD and a constitutional element corresponding to the above mentioned second wave plate is disposed, for example, between the laser beam source 19 for BD and the auxiliary lens 3.

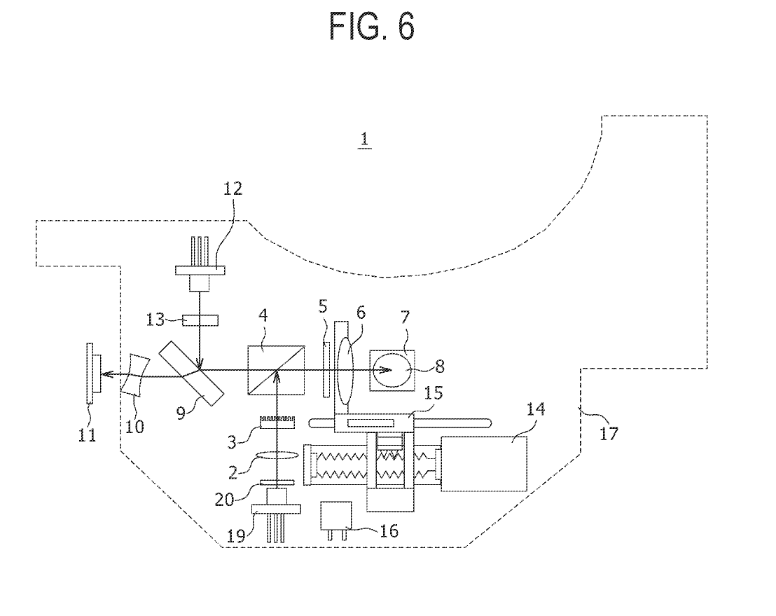

FIG. 6 is a third block diagram illustrating an example of the optical pickup 1 according to one embodiment. In the example illustrated in FIG. 6, the second wave plate 20 is disposed between the laser beam source 19 and the auxiliary lens 2 differently from the example illustrated in FIG. 2.

In the above mentioned case, the second wave plate 20 is designed as a half wave plate which is optimized to the laser light for BD, or the second wave plate 20 is designed such that the laser beam for BD outputs in a state that a phase difference with which 62.75 nm which is the difference between the quarter of the wavelength of the laser beam for BD and the quarter of the wavelength of the laser beam for DVD is corrected is given. Then, the laser beam for DVD is radiated to the optical disk 101 as circular polarization. The laser beam for BD is radiated to the optical disk 101 as 45-degree linear polarization when the former second wave plate is used and as circular polarization when the latter second wave plate is used.

Incidentally, in the former case, the second wave plate 20 is designed as the half wave plate for the laser beam for BD. However, in general, it is not limited to the half wave plate. It is sufficient that the second wave plate 20 be designed such that the laser light for DB outputs in a state that a phase difference is given so as to be converted into the 45-degreee linear polarization within a period of time from when the laser light for BD has been incident upon the second wave plate 20 to when the laser light for BD is incident upon the first wave plate 5.

In the latter case, that is, as for the method of giving the laser beam for DVD the phase difference with which the difference 62.75 nm between the quarter of the wavelength of the laser beam for BD and the quarter of the wavelength of the laser beam for DVD is corrected, other methods are conceivable. For example, a method that the second wave plate 18 works with the prism 4 to correct the difference amounting to 62.75 nm is conceivable. The constitutional element that corrects the difference is not limited to the wave plate, and connection may be made combining with a phase shift amount by another constitutional element as mentioned above. That is, it is desirable to design the second wave plate 18 such that correction of the difference amounting to 62.75 nm is made within a period of time from when the laser beam generated from the laser beam source 19 has been incident upon the second wave plate 20 to when the laser beam is incident upon the first wave plate 5.

The embodiments described so far are merely examples and do not limit the present invention. Although different embodiments are conceivable while conforming to the gist of the present invention, all the embodiments fall within the range of the present invention. For example, although many different examples are given with respect to the fundamental configurations of the optical disk device 100 and the optical pickup 1, the present invention is not limited to the configurations illustrated in FIG. 1, FIG. 2, FIG. 5 and FIG. 6.

While we have shown and described several embodiments in accordance with out invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical pickup used in an optical disk device radiating laser beams to mutually different kinds of first, second and third optical disks to read out information data from the disks, comprising:
a first laser beam source generating a laser beam of a first wavelength to be radiated to the first optical disk;
a second laser beam source generating a laser beam of a second wavelength which is longer in wavelength than the laser beam of the first wavelength and is to be radiated to the second optical disk, and a laser beam of a third wavelength which is longer in wavelength than the second wavelength and is to be radiated to the third optical disk;
a second wave plate letting the laser beam of the second wavelength generated from the second laser beam source input, giving the laser beam of the second wavelength a phase difference and then letting the laser beam of the second wavelength output, and letting the laser beam of the third wavelength input and letting the laser beam of the third wavelength output;
a first wave plate letting the laser beam of the first wavelength generated from the first laser beam source input, converting the laser beam of the first wavelength into circular polarization and then letting laser beam so converted into the circular polarization output, letting the laser beam of the second wavelength that has outputted the second wave plate input as 45-degree linear polarization and letting the laser beam of the second wavelength outputs still as the 45-degree linear polarization, and letting the laser beam of the third wavelength that has outputted the second wave plate input and letting the laser beam of the third wavelength output; and
an objective lens making the laser beams of the first to third wavelengths that have outputted the first wave plate focus on the first to third optical disks.

2. The optical pickup according to claim 1, wherein the first wave plate is a quarter wave plate for the laser beam of the first wavelength, and the second wave plate is a half wave plate for the laser beam of the second wavelength.

3. The optical pickup according to claim 1, wherein
the first wave plate is a quarter wave plate for the laser beam of the first wavelength, and
the second wave plate gives a phase difference to the laser beam of the second wavelength so as to be converted into 45-degree linear polarization within a period of time from when the laser beam of the second wavelength has been incident upon the second wave plate to when the laser beam of the second wavelength is incident upon the first wave plate and then lets the laser beam of the second wavelength output.

4. An optical pickup used in an optical disk device radiating laser beams to mutually different kinds of first, second and third optical disks to read out information data from the disks, comprising:
a first laser beam source generating a laser beam of a first wavelength to be radiated to the first optical disk;
a second laser beam source generating a laser beam of a second wavelength which is longer in wavelength than the laser beam of the first wavelength and is to be radiated to the second optical disk, and a laser beam of a third wavelength which is longer in wavelength than the second wavelength and is to be radiated to the third optical disk;
a second wave plate letting the laser beam of the second wavelength generated from the second laser beam source input, giving the laser beam of the second wavelength a phase difference and then letting the laser beam of the second wavelength output, and letting the laser beam of the third wavelength input and letting the laser beam of the third wavelength output;
a first wave plate letting the laser beam of the first wavelength generated from the first laser beam source input, converting the laser beam of the first wavelength into circular polarization and then letting the laser beam so converted into the circular polarization output, letting the laser beam of the second wavelength that has outputted the second wave plate input, converting the laser beam of the second wavelength into circular polarization and then letting the laser beam so converted into the circular polarization, and letting the laser beam of the third wavelength that has outputted the second wave plate input and letting the laser beam of the third wavelength output; and
an objective lens making the laser beams of the first to third wavelengths that have outputted the first wave plate focus on the first to third optical disks.

5. The optical pickup according to claim 4, wherein the first wave plate is a quarter wave plate for the laser beam of the first wavelength, and the second wave plate gives a phase difference corresponding to a difference between a quarter of the wavelength of the first-wavelength laser beam and a quarter of the wavelength of the second-wavelength laser beam to the laser beam of the second wavelength.

6. The optical pickup according to claim 4, wherein
the first wave plate is a quarter wave plate for the laser beam of the first wavelength, and
the second wave plate gives a phase difference to the laser beam of the second wavelength such that the phase difference is corresponding to a difference between a quarter of the wavelength of the first laser beam and a quarter of the wavelength of the second laser beam within a period of a time from when the laser beam of the second wavelength has been incident upon the second wave plate to when the laser beam of the second wavelength is incident upon the first wave plate.

7. An optical pickup used in an optical disk device radiating laser beams to mutually different kinds of first, second and third optical disks to read out information data from the disks, comprising:
a first laser beam source generating a laser beam of a first wavelength to be radiated to the first optical disk;
a second laser beam source generating a laser beam of a second wavelength which is longer in wavelength than the laser beam of the first wavelength and is to be radiated to the second optical disk, and a laser beam of a third wavelength which is longer in wavelength than the second wavelength and is to be radiated to the third optical disk;
a second wave plate letting the laser beam of the first wavelength generated from the second laser beam source input, giving the laser beam of the first wavelength a phase difference and then letting the laser beam of the second wavelength output;
a first wave plate letting the laser beam of the first wavelength that has outputted second wave plate input as 45-degree linear polarization and letting the laser beam of the first wavelength output still as the 45-degree linear polarization, letting the laser beam of the second wavelength generated from the second laser beam source input, converting the laser beam of the second wavelength into circular polarization and then letting the laser beam so converted into the circular polarization output, and letting the laser beam of the third wavelength generated from the second laser beam source input and letting the laser beam of the third wavelength output; and
an objective lens making the laser beams of the first to third wavelengths that have outputted the first wave plate focus on the first to third optical disks.

8. The optical pickup according to claim 7, wherein the first wave plate is a quarter wave plate for the laser beam of the second wavelength, and the second wave plate is a half wave plate for the laser beam of the first wavelength.

9. The optical pickup according to claim 7, wherein
the first wave plate is a quarter wave plate for the laser beam of the second wavelength, and
the second wave plate giving the laser beam of the first wavelength a phase difference so as to be converted into 45-degree linear polarization within a period of time from when the laser beam of the first wavelength has been incident upon the second wave plate to when the laser beam of the first wavelength is incident upon the first wave plate and then letting the laser beam of the first wavelength output.

10. An optical pickup used in an optical disk device radiating laser beams to mutually different kinds of first, second and third optical disks to read out information data from the disks, comprising:
a first laser beam source generating a laser beam of a first wavelength to be radiated to the first optical disk;
a second laser beam source generating a laser beam of a second wavelength which is longer in wavelength than the laser beam of the first wavelength and is to be radiated to the second optical disk, and a laser beam of a third wavelength which is longer in wavelength than the second wavelength and is to be radiated to the third optical disk;
a second wave plate letting the laser beam of the first wavelength generated from the first laser beam source input, giving the laser beam of the first wavelength a phase difference and then letting the laser beam of the first wavelength output;
a first wave plate letting the laser beam of the first wavelength that has outputted the second wave plate input, converting the laser beam of the first wavelength into circular polarization and then letting the laser beam so converted into the circular polarization output, letting the laser beam of the second wavelength generated from the second laser beam source input, converting the laser beam of the second wavelength into circular polarization and then letting the laser beam so converted into the circular polarization output, and letting the laser beam of the third wavelength generated from the second laser beam source and letting the laser beam of the third wavelength output; and
an objective lens making the laser beams of the first to third wavelengths that have outputted the first wave plate focus on the first to third optical disks.

11. The optical pickup according to claim 10, wherein the first wave plate is a quarter wave plate for the laser beam of the second wavelength, and the second wave plate gives the laser beam of the first wavelength a phase difference corresponding to a difference between a quarter of the wavelength of the first-wavelength laser beam and a quarter of the wavelength of the second-wavelength laser beam.

12. The optical pickup according to claim 10, wherein
the first wave plate is a quarter wave plate for the laser beam of the second wavelength, and
the second wave plate gives the laser beam of the first wavelength a phase difference such that the phase difference, which is corresponding to a difference between a quarter of the wavelength of the first-wavelength laser beam and a quarter of the wavelength of the second-wavelength laser beam, is given within a period of time from when the laser beam has been incident upon the second wave plate to when the laser beam is incident upon the first wave plate.

13. An optical pickup used in an optical disk device radiating laser beams to mutually different kinds of first, second and third optical disks to read out information data from the disks, comprising:
a first laser beam source generating a laser beam of a first wavelength to be radiated to the first optical disk;
a second laser beam source generating both of a laser beam of a second wavelength which is longer in wavelength than the laser beam of the first wavelength and is to be radiated to the second optical disk and a laser beam of a third wavelength which is longer in wavelength than the second wavelength and is to be radiated to the third optical disk so as to be different from the laser beam of the first wavelength in polarization direction by 45 degrees;
a wave plate letting the laser beam of the first wavelength generated from the first laser beam source input, converting the laser beam of the first wavelength into circular polarization and then letting the laser beam so converted into the circular polarization output, and letting the laser beams of the second and third wavelengths generated from the second laser beam source input and letting the laser beams of the second and third wavelengths still as 45-degree polarizations; and
an objective lens making the laser beams of the first to third wavelengths that have outputted the wave plate focus on the first to third optical disks.

14. The optical pickup according to claim 13, wherein the wave plate is a quarter wave plate for the laser beam of the first wavelength.

15. An optical pickup used in an optical disk device radiating laser beams to mutually different kinds of first, second and third optical disks to read out information data from the disks, comprising:
a first laser beam source generating a laser beam of a first wavelength to be radiated to the first optical disk;
a second laser beam source generating both of a laser beam of a second wavelength which is longer in wavelength than the laser beam of the first wavelength and is to be radiated to the second optical disk and a laser beam of a third wavelength which is longer in wavelength than the second wavelength and is to be radiated to the third optical disk, and generating the laser beams such that at least the laser beam of the second wavelength is different from the laser beam of the first wavelength in polarization direction by 45 degrees;
a wave plate letting the laser beam of the first wavelength generated from the first laser beam source input and letting the laser beam of the first wavelength output as e45-degree linear polarization, letting the laser beam of the second wavelength generated from the second laser beam source input, converting the laser beam of the second wavelength into circular polarization and then letting the laser beam of the second wavelength so converted into the circular polarization output, and letting the laser beam of the third wavelength generated from the second laser beam source input and letting the laser beam of the third wavelength output; and
an objective lens making the laser beams of the first to third wavelengths that have outputted the wave plate focus on the first to third optical disks.

16. The optical pickup according to claim 15, wherein the wave plate is a quarter wave plate for the laser beam of the second wavelength.

17. The optical pickup according to claim 1, wherein the laser beam of the first wavelength generated from the first laser beam source is a laser beam for BD having a wavelength on the order of 405 nm, the laser beam of the second wavelength generated from the second laser beam source is a laser beam for DVD having a wavelength on the order of 656 nm, and the laser beam of the third wavelength generated from the second laser beam source is a laser beam for CD having a wavelength on the order of 795 nm.

18. An optical disk device using optical pickup, comprising:
the optical pickup according to claim 1; and
a signal processing unit processing information data read out from the optical disks.
